(19) United States
(12) Patent Application Publication
(10) Pub. No.: US 2026/0171055 A1
(43) Pub. Date: Jun. 18, 2026

(54) SIGNAL GENERATION METHOD, DISPLAY CONTROL METHOD, AND PROGRAM

(71) Applicant: Yamaha Corporation, Hamamatsu (JP)

(72) Inventors: Ryunosuke DAIDO, Hamamatsu (JP); Keijiro SAINO, Hamamatsu (JP)

(21) Appl. No.: 19/529,896

(22) Filed: Feb. 4, 2026

Related U.S. Application Data
(63) Continuation of application No. PCT/JP2024/025557, filed on Jul. 17, 2024.

(30) Foreign Application Priority Data
Aug. 7, 2023 (JP) 2023-128662

(51) Int. Cl. G10H 1/00

(52) U.S. Cl. CPC G10H 1/0025; G10H 2210/111; G10H 2210/325; G10H 2220/116; G10H 2220/126

(57) ABSTRACT

A signal generation method includes acquiring intermediate feature data corresponding to a prescribed time step by providing, to a first trained model, from among sound control data including a first parameter and a second parameter for controlling generated sounds at a plurality of time steps corresponding to a passage of time, the first parameter in a prescribed time range that includes before and after the prescribed time step; updating the intermediate feature data in response to a value of the first parameter being changed; and generating a sound signal in accordance with data obtained by providing the second parameter and the intermediate feature data that has been updated to a second trained model in response to receiving a start playback instruction.

### CROSS-REFERENCE TO RELATED APPLICATIONS

This application is a continuation application of International Application No. PCT/JP 2024/025557, filed on Jul. 17, 2024, which claims priority to Japanese Patent Application No. 2023-128662 filed in Japan on Aug. 7, 2023. The entire disclosures of International Application No. PCT/JP2024/025557 and Japanese Patent Application No. 2023-128662 are hereby incorporated herein by reference.

### BACKGROUND

### Technical Field

This disclosure generally relates to a technique for generating sound signals.

### Background Information

A technique in which a deep neural network (DNN) is used to synthesize sound is known from the prior art. As shown in Patent Document (International Publication No. 2021/251364), a technique has also been developed in which information after the timing of synthesizing sound is used to further improve the quality of the synthesized sound.

### SUMMARY

A digital audio workstation (DAW) used in music production has a function as software that generates a sound in accordance with the playback position. The DAW not only generates sounds but also provides a user interface for facilitating editing of various data.

A typical DAW uses waveform data, MIDI (Musical Instruments Digital Interface) data, etc., to generate sound signals. When using data (sound control data) for controlling generated sounds such as MIDI data, sound signals are generated using information (current information) corresponding to the playback position and information (past information) corresponding to a time before the playback position. Therefore, a technique for using information (future information) corresponding to a time after the playback position to generate a synthesized sound cannot be directly applied to the DAW. In the following description, the technique for using future information to generate a synthesized sound can be simply referred to as sound synthesis technique.

When using such a sound synthesis technique in the DAW, waveform data corresponding to synthesized sounds are typically generated in advance by an external function, such as a plug-in. The DAW can use the waveform data generated in advance by the external function to generate a sound signal corresponding to the playback position in the same way as with normal waveform data.

On the other hand, because it is necessary to generate waveform data in advance, it is difficult to edit while listening to the sound, resulting in a decrease in music production efficiency. In addition to sound synthesis techniques that use such future information, the convenience when editing a musical piece in real time in the DAW greatly affects music production efficiency.

One object of this disclosure is to improve music production efficiency in a software environment for generating sounds corresponding to the playback position.

A signal generation method according to this disclosure comprises: acquiring intermediate feature data corresponding to a prescribed time step by providing, to a first trained model, from among sound control data including a first parameter and a second parameter for controlling generated sounds at a plurality of time steps corresponding to a passage of time, the first parameter in a prescribed time range that includes before and after the prescribed time step; updating the intermediate feature data in response to a value of the first parameter being changed; and generating a sound signal in accordance with data obtained by providing the second parameter and the intermediate feature data that has been updated to a second trained model, in response to receiving a start playback instruction.

A signal generation method according to this disclosure comprises: displaying a first area including a first image corresponding to a first parameter for controlling a generated sound of a first track, the first parameter including phoneme information or pitch information, a second area including a second image corresponding to a second parameter for controlling the generated sound of the first track, and a third area including a third image corresponding to a third parameter for controlling a generated sound of a second track; displaying the first image and second image that correspond to a current playback position in the first area and the third area in response to receiving a start playback instruction; generating a first sound signal of the first track and a second sound signal of the second track that correspond to the playback position; outputting a mixed sound of the first sound signal and the second sound signal; and in response to receiving an instruction to change the second parameter after the start playback instruction, reflecting the second parameter that has been changed on the first sound signal at the playback position.

A display control method according to this disclosure comprises determining a control value for controlling generated sounds in accordance with a passage of time based on an instruction value from an operator and a set value determined in advance in a time series, generating a sound signal based on the control value and sound control data for controlling the generated sounds corresponding to the passage of time, and displaying a setting image including a first image area for indicating the instruction value and a second image area adjacent to the first image area for indicating the control value.

A display control method according to this disclosure comprises: displaying, in a prescribed display area, a first image corresponding to a sound signal generated based on sound control data including a first parameter and a second parameter for controlling generated sounds corresponding to a passage of time; changing a position of the second image in the prescribed display area in accordance with an input instruction; and moving the first image to an area that satisfies a predetermined condition from among a plurality of areas obtained by dividing the prescribed display area with the second image as reference, in response to changing the position of the second image.

### BRIEF DESCRIPTION OF THE DRAWINGS

FIG. 1 is a block diagram showing a data processing device according to one embodiment.

FIG. 2 is an example of a music editing screen according to the one embodiment.

FIG. 3 is a functional block diagram showing a sound output unit according to the one embodiment.

FIG. 4 is a functional block diagram showing a sound generation unit according to the one embodiment.

FIG. 5 is a flowchart showing a signal generation method according to the one embodiment.

FIG. 6 is a flowchart showing a signal generation method according to the one embodiment.

FIG. 7 is a flowchart showing a sound playback process according to the one embodiment.

FIG. 8 is a flowchart showing a signal generation method according to the one embodiment.

FIG. 9 is an example of a music editing screen according to the one embodiment.

FIG. 10 is an example of a setting image according to the one embodiment.

FIG. 11 is a flowchart showing a display control method according to the one embodiment.

FIG. 12 is an example of an editing window according to the one embodiment.

FIG. 13 is an example of an editing window according to the one embodiment.

FIG. 14 is a flowchart showing a display control method according to the one embodiment.

FIG. 15 is a diagram for explaining the positional relationship between a setting window image and a sound-related image according to the one embodiment.

FIG. 16 is a diagram for explaining the positional relationship between a setting window image and a sound-related image according to the one embodiment.

### DETAILED DESCRIPTION OF THE EMBODIMENTS

Selected embodiments will now be explained in detail below, with reference to the drawings as appropriate. It will be apparent to those skilled from this disclosure that the following descriptions of the embodiments are provided for illustration only and not for the purpose of limiting the invention as defined by the appended claims and their equivalents.

One embodiment of this disclosure will be described in detail below, with reference to the drawings. The following embodiment is merely an example, and this disclosure is not to be construed as being limited to this embodiment. In the drawings being referenced in the present embodiment, parts that are the same or that have similar functions are assigned the same or similar symbols, and redundant explanations can be omitted. For the purpose of clarifying the explanation, the drawings can be schematically described, such as the dimensional proportions being different from actual proportions, and some of the configurations being omitted from the drawings.

### Overview

A data processing device according to one embodiment of this disclosure is a device equipped with a computer, such as a desktop terminal, a notebook terminal, a smartphone, or a tablet terminal. The data processing device executes an installed application program to provide, to a user, the DAW for editing musical pieces and the like. The DAW generates a sound signal based on data set in correspondence with a plurality of tracks, such as sound control data, waveform data, and other information for generating sound.

The sound control data are data containing information for controlling generated sounds at a plurality of time steps corresponding to the passage of time, an example being MIDI data. Waveform data are data obtained by sampling sound signal waveforms, examples being WAV (Waveform Audio File Format) data, MP3 (MPEG-1/2 Audio Layer III) data, and the like. The DAW reads, from data of each track, information corresponding to the playback position and generates a sound signal corresponding to the playback position. As a result of sound signals corresponding to a plurality of tracks being generated in synchronization, a sound obtained by mixing sounds corresponding to each of the tracks (mixed sound) is output.

To generate a sound signal, at least information corresponding to the playback position, that is, current information is used. When a sound signal is generated in accordance with sound control data, or the like, information corresponding to a time before the playback position, that is, past information also affects the sound signal generated in accordance with the playback position. In this example, information of the sound control data corresponding to a time after the playback position, that is, sound control data for using a sound synthesis technique that further uses future information, can also be allocated to at least one of the plurality of tracks.

According to this sound synthesis technique, in this example, a sound imitating human voice can be generated at a set pitch. Sounds imitating human voice are referred to as a synthesized singing sound in the following description. In addition to the synthesized singing sound, this sound synthesis technique can be used to generate synthesized musical instrument sounds. In the following description, unless otherwise specified, a process for generating the synthesized singing sound is a process using a sound synthesis technique using past information, current information, and future information. A method for realizing this process can be understood by a person skilled in the art based on the disclosure (in particular, the disclosure of the second embodiment) of the above-mentioned Patent Document (International Publication No. 2021/251364). The data processing device will now be described.

### Data Processing Device

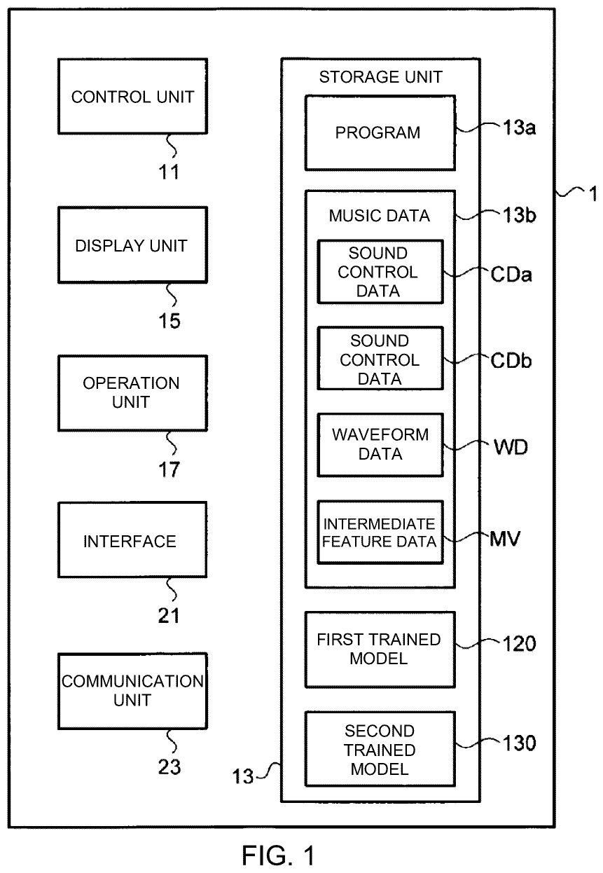

FIG. 1 is a block diagram showing a data processing device according to the one embodiment. The data processing device 1 comprises a control unit 11, a storage unit 13, a display unit 15, an operation unit 17, an interface 21, and a communication unit 23. The control unit (electronic controller) 11 is one example of a computer equipped with a processor, such as a CPU, and a storage device, such as RAM (Random-access memory). The control unit 11 executes a program 13a stored in the storage unit 13 using the CPU to realize functions for executing various processes in the data processing device 1. The various processes include a process for realizing functions relating to the DAW. This process includes a process relating to a signal generation method and a process relating to a display control method, described further below. Accordingly, the control unit 11 also functions as a signal generation unit for executing the signal generation method and a display control unit for executing the display control method.

The display unit 15 is a display having a display area for displaying various screens under the control of the control unit 11. The various screens include a music editing screen, described further below. The operation unit (user operable input) 17 is a device for inputting user instructions, and is an operation device including operators that output, to the control unit 11, operation signals corresponding to the operation that has been input. The operators are, for example, slider-type operators such as faders, rotary-type operators such as knobs and rotary encoders, and button-type operators such as switches. The operators can be provided as operator images displayed on the display unit 15. The operation signal includes information relating to an instruction value of an operator.

The interface 21 includes a module for communicating with an external device by wired communication, or wireless communication such as infrared communication or short-range wireless communication. In this example, the external device can be a sound source device, an electronic instrument, or the like that generates sound signals, or can be a speaker, headphones, or the like that outputs, to the outside, sound signals generated by the control unit 11. The interface 21 is used for communication without using a network. The communication unit 23 is a communication module that, under the control of the control unit 11, connects with a network to communicate with an external device that is connected to the network.

The storage unit (computer memory) 13 is a storage device such as non-volatile memory or a hard disk drive. The storage unit 13 stores the program 13a executed in the control unit 11, and various data required for the DAW realized by this program 13a. For example, the storage unit 13 stores music data 13b, a first trained model 120, and a second trained model 130.

The program 13a is downloaded from an external device via a network such as the Internet and stored in the storage unit 13, thereby being installed in the data processing device 1. The program 13a can be provided in a state of being recorded in a non-transitory, computer-readable recording medium (such as a magnetic recording medium, an optical recording medium, a magneto-optical recording medium, or a semiconductor memory). In this case, the data processing device 1 needs only to be equipped with a device that can read from the recording medium. The storage unit 13 is also one example of the recording medium.

Similarly, the music data 13b, the first trained model 120, and the second trained model 130 can be downloaded from an external device via a network and stored in the storage unit 13, or be provided in a state of being stored in a non-transitory, computer-readable recording medium. The music data 13b are data stored in the storage unit 13 for each musical piece, and include sound control data CDa, CDb, waveform data WD, intermediate feature data MV, and the like. These data can be generated in the process of music production using the DAW, or can be provided to the data processing device 1 in advance in the same manner as the program 13a.

The sound control data CDa, CDb are, for example, MIDI format data, containing a plurality of types of parameters for controlling generated sounds at a plurality of time steps corresponding to the passage of time. In this example, the sound control data CDa are data used when generating the synthesized singing sound. The sound control data CDb, are data used when generating musical instrument sounds. The plurality of parameters in the sound control data CDa are divided into at least parameters belonging to a first group and parameters belonging to a second group. The parameters in the first group can include parameters corresponding to future information and be referred to as a first parameter P1. The parameters in the second group can include parameters corresponding to current information and be referred to as a second parameter P2. The second parameter P2 can include parameters related to past information. The information respectively included in the first parameter P1 and the second parameter P2 described below is merely an example, and there can be combinations other than those described below.

The first parameter P1 includes information determined for each note defined in a time series. The first parameter P1 includes, for example, at least one or more of phoneme information, pitch information, duration information, or intensity information. The first parameter P1 includes at least phoneme information or pitch information. The phoneme information includes, for each note, information for generating a sound from text such as lyrics for singing. When the sound control data are the sound control data CDb for generating musical instrument sounds, it is not necessary to use the phoneme information, or the phoneme information can be used as information other than lyrics, such as information for reproducing a playing style of a musical instrument. The pitch information includes, for each note, information for specifying the pitch. The duration information includes, for each note, information for specifying the start position and the duration (note value) of the note. The duration information can be defined by a plurality of pieces of information, such as note on and note off. The intensity information includes, for each note, information for specifying the velocity.

The second parameter P2 includes information for controlling a generated sound at each time step. The second parameter P2 includes, for example, at least one or more of power information, transpose information, or formant information. The power information includes information for specifying the dynamics of a note; for example, when the setting value is large, a sound of a shouting voice is reproduced, and when the setting value is small, a sound of a whispering voice is reproduced. The transpose information includes information for raising or lowering the pitch of the note. The formant information includes information for specifying voice quality; for example, when the setting value is large, a sound similar to a male voice is reproduced, and when the setting value is small, a sound similar to a female voice is reproduced. The second parameter P2 also can be information for specifying the clarity and brightness of voice, the breath, how the mouth is opened, and the like.

The setting value of the information included in the second parameter P2 can be used as a value (control value) for controlling the generated sound, or can be used as a control value after being updated or corrected in accordance with instruction information. The instruction information includes information corresponding to an instruction value of an operator. That is, the control value relating to the second parameter P2 can be determined based on the setting value and the instruction value. In this case, since the instruction value is related to the setting value of the information included in the second parameter P2, it can be said that the instruction information is one example of the second parameter P2. For example, when the control value of the power information is determined based on the instruction value, it can be said that the instruction value is power information.

The plurality of parameters in the sound control data CDb include at least parameters belonging to a third group. The parameters in the third group can include parameters corresponding to current information and be referred to as a third parameter P3. The third parameter P3 can include parameters related to past information.

The third parameter P3 includes information determined for each note defined in a time series, and information for controlling a generated sound at each time step. The former information is similar to the above-mentioned first parameter P1, but is information used, not as future information, but as current information or past information. The latter information is the same as the above-mentioned second parameter P2. The third parameter P3 includes, for example, at least one or more of pitch information, or duration information, intensity information. The third parameter P3 can include transpose information, and the like.

When the sound control data CDb are data for generating sounds of percussion instruments, such as the drums, information specifying the type of percussion instrument, such as snare, tom, or cymbal, can be included. A percussion instrument may not require pitch information, and type information can be included in the third parameter P3 instead of the pitch information as information for specifying the type of percussion instrument. The pitch information can be specified by a note number, for example, but the type information is also specified by a note number. Accordingly, there are cases in which data are in the form of pitch information but are not information indicating pitch.

The waveform data WD are data obtained by sampling sound signal waveforms, and indicate waveform data corresponding to each time step. The intermediate feature data MV are data generated by the first trained model 120, and are, for example, vector data corresponding to each time step.

The first trained model 120 and the second trained model 130 are statistical estimation models used when the synthesized singing sound is generated, and, in this example, a known machine learning model using DNN (deep neural network) is used. Different types of models can be respectively applied to the first trained model 120 and the second trained model 130. For example, the machine learning model can be a machine learning model that uses a convolutional neural network (CNN), a recurrent neural network (RNN), or the like. Details of the first trained model 120 and the second trained model 130 will be described further below.

### Musical Piece Editing Screen

The music editing screen will be described. The music editing screen is a screen provided by the DAW realized in the data processing device 1.

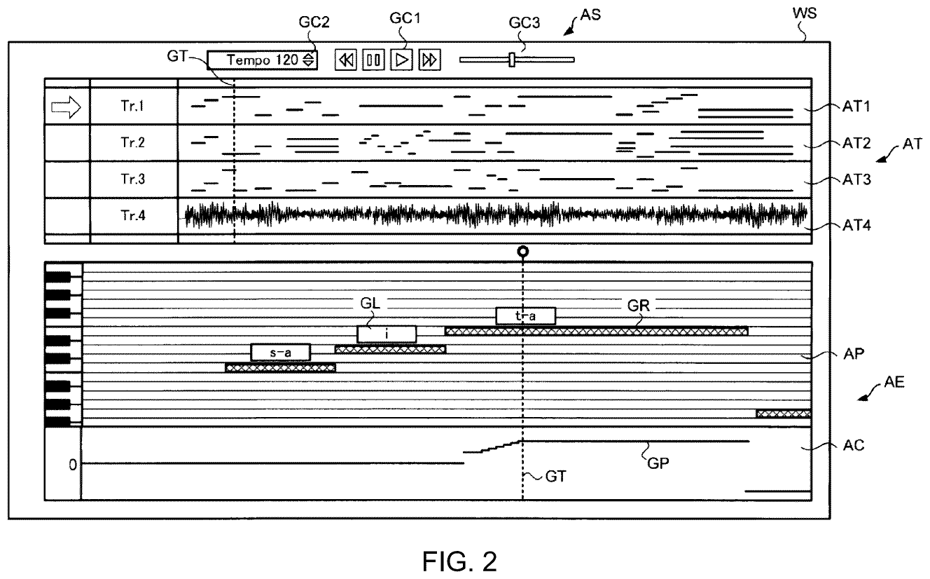

FIG. 2 is an example of a music editing screen according to the one embodiment. In the example shown in FIG. 2, the music editing screen WS includes a tracks area AT, an editing area AE, and an operation image area AS. In all cases, the horizontal direction indicates the temporal position, i.e., the time step. When executing a playback process, an image GT indicating the playback position is displayed in the tracks area AT and the editing area AE.

The tracks area AT is an area for displaying images corresponding to data corresponding to each track and, in this example, includes areas AT1, AT2, AT3, and AT4 corresponding to the first to the fourth tracks. The sound control data CDa are assigned to the first track, the sound control data CDb are assigned to the second track and the third track, and the waveform data WD are assigned to the fourth track. Accordingly, an image (first image) corresponding to the first parameter P1 in the sound control data CDa is displayed in the area AT1 (first area). Images (third image(s)) corresponding to the third parameter P3 in the sound control data CDb are displayed in the areas AT2 and AT3 (third area).

In this example, the editing area AE includes a piano roll area AP and a setting value area AC. The piano roll area AP is an area (first area) in which information of the first parameter P1 is displayed when the sound control data CDa are assigned to the track selected in the tracks area AT, and in which a sound control image corresponding to the first parameter P1 is displayed. The piano roll area AP is an area (third area) in which information of the third parameter P3 is displayed when the sound control data CDb are assigned to the tack selected in the tracks area AT, and in which is displayed a sound control image corresponding to the third parameter P3.

The sound control image is, for example, an image GL indicating phoneme information, and an image GR indicating pitch information and duration information. Other information such as intensity information can be expressed using the color of the image GR, the width of the band, or the like. The image GR includes information determined for each note defined in a time series, and includes information of the first parameter P1 in the case of the sound control data CDa, and includes information of the third parameter P3 in the case of the sound control data CDb. When waveform data WD are assigned to the track selected in the track area AT, the area in the piano roll area AP for displaying waveforms is replaced with the editing area AE.

The setting value area AC (second area) displays an image GP (second image) indicating the setting value of information for controlling the generated sound at each time step. That is, the image GP includes information of the second parameter P2 in the case of the sound control data CDa, and includes information of the third parameter P3 in the case of the sound control data CDb. An image relating to information of the first parameter P1 that is not displayed in the editing area AE can be displayed in the setting value area AC, in conjunction with the editing area AE.

When a user instructs an operation to change an image via the operation unit 17 or the interface 21 to thereby change the position of the image corresponding to information of each piece of data, such as the image GP or the image GR in the music editing screen WS, the information on the corresponding data is changed. Accordingly, it can be said that an image displayed in the piano roll area AP is an image related to a change in the first parameter P1 or the third parameter P3. It can also be said that an image displayed in the setting value area AC is an image related to a change in the second parameter P2 or the third parameter P3.

In this example, the operation image area AS contains operation images GC1, GC2, GC3 for receiving user instructions. The operation image GC1 is an image imitating a button for receiving instructions such as start playback, end playback, and the like. The operation image GC2 is an image imitating a button for receiving a setting of the movement speed of the playback position, i.e., tempo information. The operation image GC3 is an image imitating a slider for receiving volume settings.

### Sound Output Unit

The function of the sound output unit realized by the control unit 11 executing the program 13a will be described.

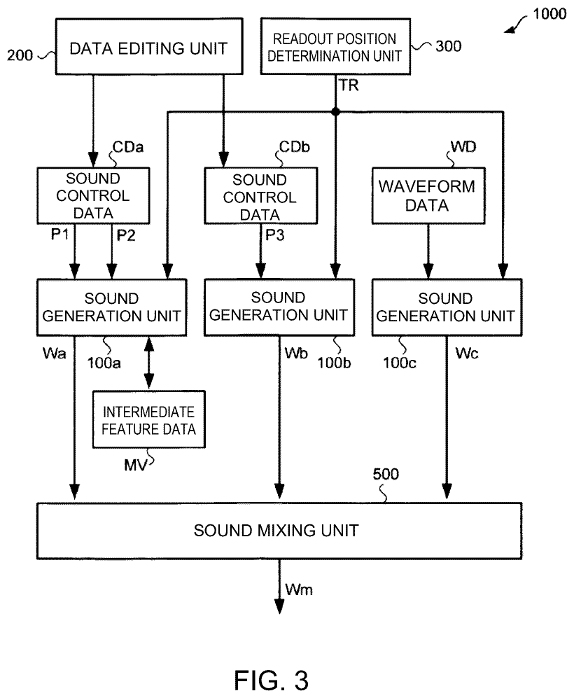

FIG. 3 is a functional block diagram showing a sound output unit according to the one embodiment. The sound output unit 1000 includes sound generation units 100a, 100b, 100c, a data editing unit 200, a readout position determination unit 300, and a sound mixing unit 500. This disclosure is not limited to a case in which all configurations of the sound output unit 1000 are realized as software by executing a program; at least some of the configurations can be realized by hardware.

The data editing unit 200 edits the information of the sound control data CDa, CDb in accordance with user instructions and updates the data. The data editing unit 200 can edit the waveform data WD in accordance with user instructions. The readout position determination unit 300 generates a readout position TR in accordance with the playback instruction and the value of the tempo information. The tempo information can be a value set using the operation image GC2, or a value set in the sound control data CDa, CDb. In this example, the readout position TR is expressed by the time step position.

The sound generation unit 100a generates a sound signal Wa (first sound signal) corresponding to the track to which the sound control data CDa are assigned. The sound generation unit 100a generates intermediate feature data MV during the generation process of the sound signal Wa. The sound generation unit 100b generates a sound signal Wb (second sound signal) corresponding to the track to which the sound control data CDb are assigned. The sound generation unit 100c generates a sound signal Wc corresponding to the track to which the waveform data WD are assigned. The sound generation units 100a, 100b, 100c read data in accordance with the readout position TR to generate the sound signals Wa, Wb, Wc. In this manner, as the playback position advances and the readout position TR advances, sound signals Wa, Wb, Wc corresponding to the playback positions are output. When the playback position advances in accordance with the readout position TR, the position of the image GT displayed on the music editing screen WS described above also moves in accordance with the readout position TR.

The sound signal Wa includes information of the first parameter P1 and thus includes information after the playback position, that is, future information. The sound signal Wb includes information of the third parameter P3 and thus includes information at or before the playback position, that is, current information or past information.

The sound mixing unit 500 mixes sound signals generated in each track (sound signals Wa, Wb, Wc in the example shown in FIG. 3) and outputs a mixed sound signal Wm.

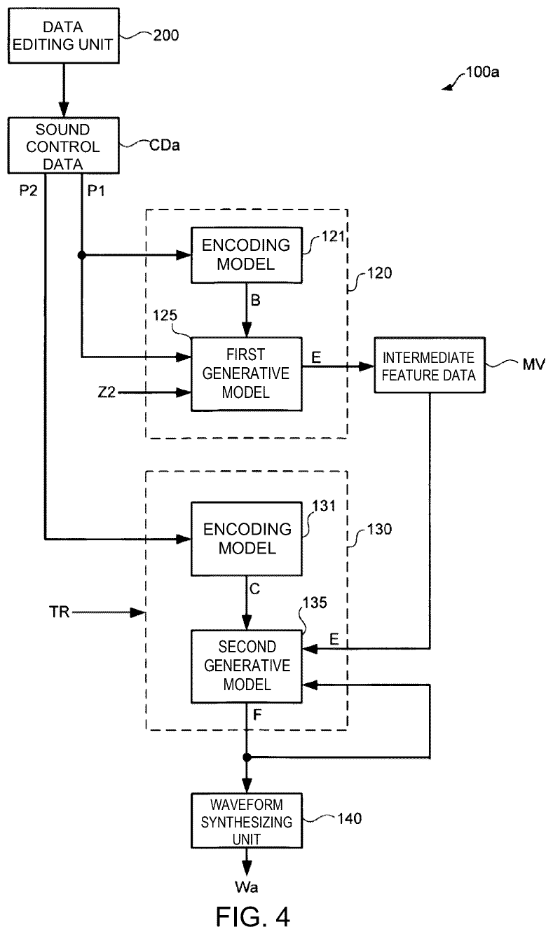

FIG. 4 is a functional block diagram showing a sound generation unit according to the one embodiment. FIG. 4 shows a detailed configuration of the sound generation unit 100a. The sound generation unit 100a contains the first trained model 120 and the second trained model 130 described above, and further contains a waveform synthesizing unit 140. The first trained model 120 includes an encoding model 121 and a first generative model 125.

The first trained model 120 is a model trained so as to generate intermediate feature data MV at a prescribed time step, when provided with the first parameter P1 and a tempo Z2 in a prescribed time range including before and after said time step. The tempo Z2 is a value of the tempo information. The second trained model 130 includes an encoding model 131 and a second generative model 135. The second trained model 130 is a model trained so as to generate sound feature data F at a prescribed time step, when provided with a second parameter P2 and intermediate feature data MV at said time step. At this time, sound feature data F from before said time step can be provided.

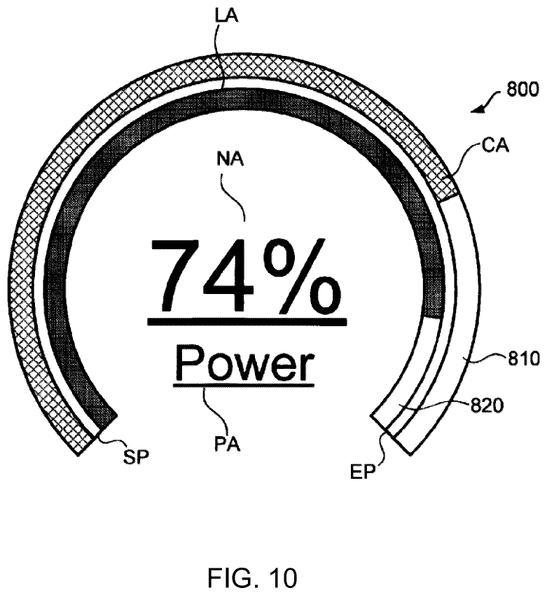

As described above, the configuration of the sound generation unit 100a is similar to the configuration of the second embodiment shown in FIG. 10 of the Patent Document (International Publication No. WO 2021/251364). Accordingly, while a detailed description will be omitted, a person skilled in the art would be able to implement the configuration by referencing the disclosure in the Patent Document (International Publication No. WO 2021/251364).

The encoding model 121 is a statistical estimation model for generating symbol data B at each time step based on the first parameter P1 of the sound control data CDa. Information of the first parameter P1 used in the encoding model 121 includes phoneme information. The first generative model 125 is a statistical estimation model for generating encoded data E at each time step, based on the symbol data B, the tempo Z2, and the first parameter P1. Information of the first parameter P1 used in the first generative model 125 includes, for example, pitch information. The encoding model 121, the first generative model 125, the first parameter P1, the tempo Z2, the symbol data B, and the encoded data E respectively correspond to the encoding model (21), the encoded data acquirer (22), the music data (D), the tempo (Z2), the symbol data (B), and the encoded data (E) in the Patent Document (International Publication No. WO 2021/251364).

The encoded data E at each time step are generated using information of the first parameter P1 in a prescribed time range including before and after the corresponding time step. That is, the encoded data E are generated using not only current information but also at least future information. The encoded data E corresponding to a plurality of time steps are acquired as intermediate feature data MV. The acquired intermediate feature data MV are stored in the storage unit 13. In addition, if the intermediate feature data MV have not been generated, the control unit 11 first provides information of the first parameter P1 to the first trained model 120. Processing in the first trained model 120 is executed using the provided information, and the encoded data E are generated for each time step included in the period in which the first parameter P1 exists.

When the data editing unit 200 updates the tempo information or the information of the first parameter P1 in the sound control data CDa after the intermediate feature data MV are stored, the control unit 11 provides the updated information to the first trained model 120. Processing in the first trained model 120 is executed using the provided information, and the intermediate feature data MV are updated using the newly generated encoded data E. At this time, the information can be provided to the first trained model 120 such that the entire intermediate feature data MV can be updated, or only the intermediate feature data MV of the time range that will be affected by the updated information are updated.

The encoding model 131 is a statistical estimation model for generating encoded control data C at each time step based on the second parameter P2 of the sound control data CDa. The above-mentioned second generative model 135 reads, from the intermediate feature data MV, the encoded data E of the time step corresponding to the readout position TR. The second generative model 135 is a statistical estimation model for generating the sound feature data F of the time step corresponding to the readout position TR, based on the encoded data E that have been read, the control data C, and the sound feature data F generated at a past time step (time step before the time step corresponding to the readout position TR).

The encoding model 131, the second generative model 135, the second parameter P2, the control data C, and the sound feature data F respectively correspond to the generative model 32, the generative model 40, the indication value Z1, the control data C, and the acoustic feature data F in the Patent Document (International Publication No. WO 2021/251364). Here, while the second parameter P2 is information stored in the storage unit 13, the instruction value Z1 in the Patent Document (International Publication No. WO 2021/251364) is instructed by a user. The second parameter P2 provided to the second trained model 130 is a control value and is information that can be updated by a user instruction. Accordingly, the second parameter P2 can be treated in the same manner whether the second parameter P2 is information updated in real time by a user instruction or information that is predetermined.

The value (control value) of the second parameter P2 provided to the second trained model 130 can be a value obtained by correcting, using an instruction value of the instruction information, the value (setting value) of the second parameter P2 of the sound control data CDa stored in the storage unit 13. In this case, the updated sound control data CDa does not need to be stored in the storage unit 13. The value (control value) of the second parameter P2 provided to the second trained model 130 can be the value (setting value) of the second parameter P2 of the sound control data CDa stored in the storage unit 13, or be an instruction value of the instruction information.

When a user instructs start of playback, the control unit 11 provides, to the second trained model 130, the second parameter P2 at the time step corresponding to the readout position TR, and the encoded data E corresponding to said time step among the intermediate feature data MV. Data are provided to the first trained model 120 when information of the first parameter P1 is updated, but the timing at which these data are provided to the second trained model 130 is not when information of the second parameter P2 is updated. Processing in the second trained model 130 is executed using the provided information, and sound feature data F indicating features of the sound signal at each time step are output.

The waveform synthesizing unit 140 corresponds to the waveform synthesizer (50) in the Patent Document (International Publication No. WO 2021/251364), and synthesizes a sound signal at each time step in accordance with the sound feature data F, thereby generating the sound signal Wa. In this manner, as the playback position advances and the readout position TR advances, the sound generation unit 100a outputs a sound signal Wa corresponding to the playback position.

In the sound generation unit 100a, the intermediate feature data MV are updated when information of the first parameter P1 is updated, but when the information of the second parameter P2 is updated, the intermediate feature data MV are not updated. On the other hand, if information of the second parameter P2 is updated after an instruction to start playback, the second trained model 130 is provided with information reflecting the update in real time. Accordingly, updated information of the second parameter P2 is also reflected on the generated sound signal Wa.

If the information of the first parameter P1 is updated after an instruction to start playback, the intermediate feature data MV can be updated after the playback ends, or the intermediate feature data MV can be updated during playback. In the latter case, if the position is a certain distance away after the playback position, updated information relating to the first parameter P1 is also reflected on the sound signal Wa that is generated when the playback position reaches said position.

### Signal Generation Method (DAW)

The signal generation method executed in the control unit 11 will now be described. The signal generation method described here is started when the program 13a is executed. First, the overall flow of the DAW will be described.

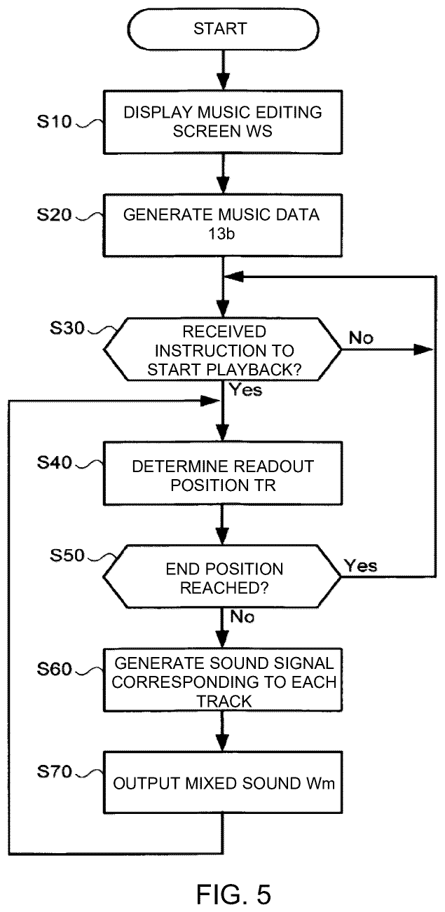

FIG. 5 is a flowchart showing a signal generation method according to the one embodiment. The control unit 11 displays the music editing screen WS (step S10). As described above, the music editing screen WS includes the tracks area AT and the editing area AE. The tracks area AT displays an image corresponding to the first parameter P1 for controlling the generated sound if the sound control data CDa are assigned to the track, and displays an image corresponding to the third parameter P3 for controlling the generated sound if the sound control data CDb are assigned to the track.

The editing area AE includes the piano roll area AP and the setting value area AC. If the sound control data CDa are assigned to the track, the piano roll area AP is used as an area for changing the information of the first parameter P1 by displaying an image relating to changing the first parameter P1. If the sound control data CDa are assigned to the track, the setting value area AC is used as an area for changing the information of the second parameter P2 by displaying an image relating to changing the second parameter P2. The editing window described further below is another example of displaying an image relating to changing the second parameter P2. If the sound control data CDb are assigned to the track, the piano roll area AP and the setting value area AC are used as areas for changing the information of the third parameter P3 by displaying an image relating to changing the third parameter P3.

The control unit 11 generates the music data 13b by editing the information of various parameters in accordance with user instructions (step S20). The control unit 11 waits for an instruction to start playback from the user (step S30; No). When an instruction to start playback is received (step S30; Yes), the control unit 11 determines the readout position TR so as to advance the playback position for each time step (step S40). When the readout position TR reaches the end position of the music data 13b (step S50; Yes), the control unit 11 waits again for an instruction to start playback (step S30; No).

If the readout position TR has not reached the end position of the music data 13b (step S50; No), the control unit 11 generates sound signals corresponding to each track (step S60), generates a mixed sound Wm of the sound signals corresponding to each track (step S70), returns to the process of step S40, and determines the readout position TR to which the playback position has been advanced.

### Signal Generation Method (Sound Generation Unit 100a)

A signal generation method executed in the sound generation unit 100a for generating sounds of a track to which the sound control data CDa have been assigned will now be described. When the sound control data CDa are assigned, the process described below is started.

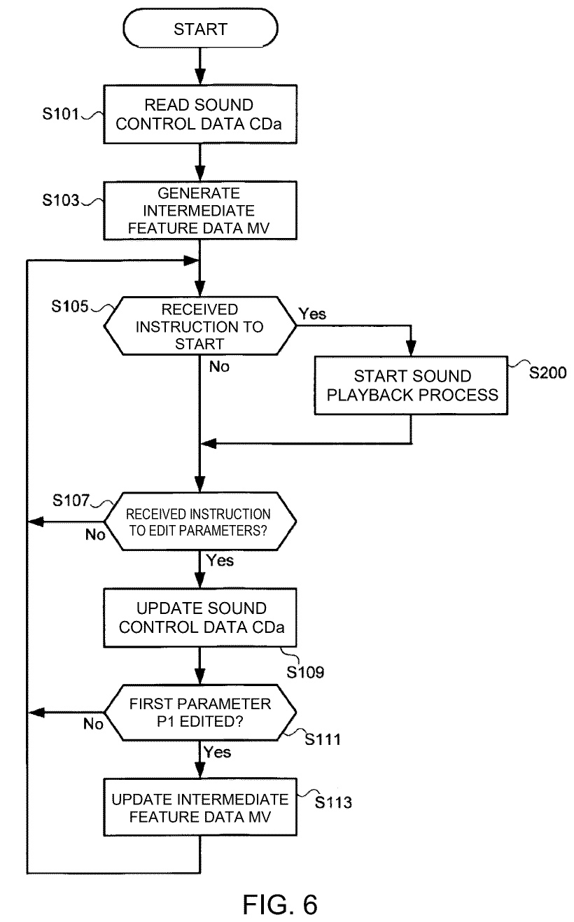

FIG. 6 is a flowchart showing a signal generation method according to the one embodiment. The control unit 11 reads the sound control data CDa (step S101) and generates the intermediate feature data MV (step S103). The control unit 11 waits for an instruction to start playback or an instruction to edit parameters from the user (step S105; No, S107; No). This state is referred to as the standby process in the explanation of FIG. 6.

In the standby process, when an instruction to edit parameters is received (step S107; Yes), the control unit 11 updates the sound control data CDa in accordance with the instruction (step S109). If the first parameter P1 has not been edited (step S111; No), the control unit 11 returns to the standby process. If the first parameter P1 has been edited (step S111; Yes), the control unit 11 updates the intermediate feature data MV (step S113) and returns to the standby process. When an instruction to start playback is received during the standby process (step S105; Yes), the control unit 11 starts a sound playback process (step S200) and returns to the standby process again.

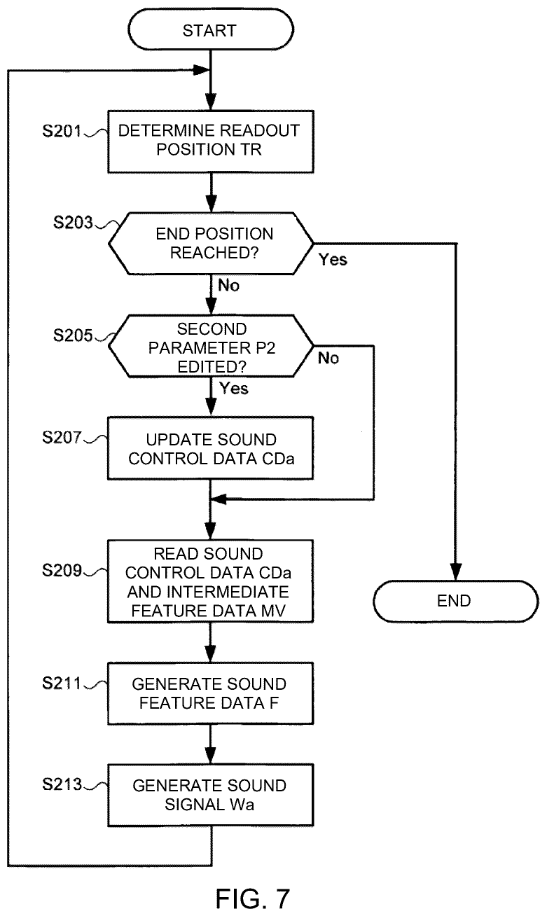

FIG. 7 is a flowchart showing a sound playback process according to the one embodiment. The sound playback process can be executed in parallel with the process from step S105 to step S113, or be configured to not proceed beyond the standby process while the sound playback process is being executed.

The control unit 11 determines the readout position TR so as to advance the playback position for each time step (step S201). When the readout position TR reaches the end position of the music data 13b (step S203; Yes), the control unit 11 ends the playback process. If the readout position TR has not reached the end position of the music data 13b (step S203; No), the control unit 11 reads the intermediate feature data MV and the sound control data CDa corresponding to the time step corresponding to the readout position TR (step S209), if the second parameter P2 has not been edited (step S205; No). If the second parameter P2 has been edited (step S205; Yes), the control unit 11 updates the sound control data CDa (step S207) and executes the process of step S209.

The control unit 11 generates the sound feature data F using the data that have been read (step S211), generates the sound signal Wa (step S213), returns to the process of step S201, and determines the readout position TR in which the playback position has been advanced.

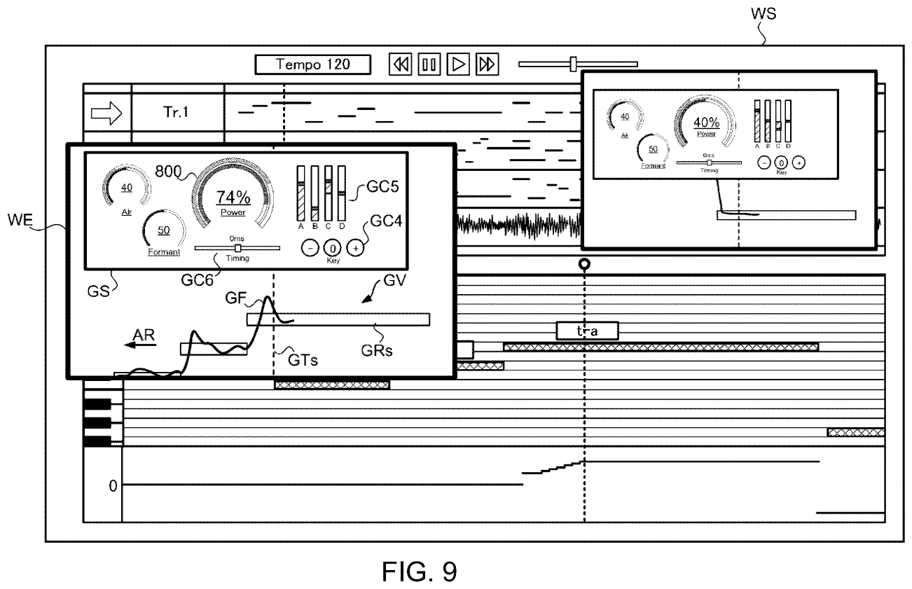

In this manner, when the information of the first parameter P1 is updated, the sound generation unit 100a executes a process that uses future information regardless of the playback position to generate the intermediate feature data MV, and executes processes that do not use future information in accordance with the playback position. As a result, the sound generation unit 100a can generate the sound signal Wa on which updates to the information are reflected, even when using a sound synthesis technique that includes future information. That is, information of the first parameter P1 and the second parameter P2 that has been changed by editing is reflected on the sound signal Wa. In particular, even after an instruction to start playback is issued, there are cases in which the sound signal Wa reflects information of the second parameter P2 and also reflects information of the first parameter P1. Accordingly, it is possible to improve the music production efficiency in a software environment in which sound is generated in accordance with the playback position, such as a DAW. When the user changes the second parameter P2 using a user interface provided on a music editing screen W3 shown in FIG. 9, the second parameter P2 that has been changed is immediately reflected on the generation of the sound signal Wa, even after playback has started. Accordingly, the user can experience being able to check, in real time, sounds that have been generated using a sound synthesis technique that includes future information.

### Signal Generation Method (Sound Generation Unit 100b)

A signal generation method executed in the sound generation unit 100b for generating sounds of a track to which the sound control data CDb have been assigned will now be described. When the sound control data CDb are assigned, and an instruction to start playback is received, the process described below is started.

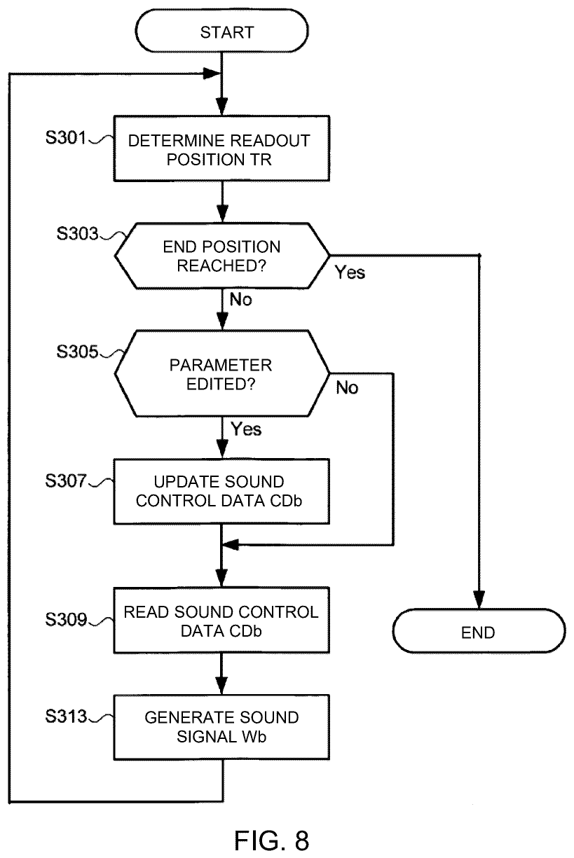

FIG. 8 is a flowchart showing a signal generation method according to the one embodiment. The control unit 11 determines the readout position TR so as to advance the playback position for each time step (step S301). When the readout position TR reaches the end position of the music data 13b (step S303; Yes), the control unit 11 ends the process. If the readout position TR has not reached the end position of the music data 13b (step S303; No), the control unit 11 reads the sound control data CDb (corresponding to the information of the third parameter P3) corresponding to the time step corresponding to the readout position TR (step S309), if the parameter has not been edited (step S305; No). If the parameter has been edited (step S305; Yes), the control unit 11 updates the sound control data CDb (step S307) and executes the process of step S309. The control unit 11 generates the sound signal Wb using the data that have been read (step S313), returns to the process of step S301, and determines the readout position TR to which the playback position has been advanced. In this manner, even after an instruction to start playback is issued, the sound signal Wb reflects the information of the third parameter P3 after having been changed by editing.

### Editing Window

An editing window that can be displayed by inputting a prescribed operation on the music edit screen W3 will now be described.

FIG. 9 is an example of the music editing screen WE according to the one embodiment. An editing window WE is displayed, under the control of the control unit 11, on the music editing screen W3 shown in FIG. 9. The editing window WE can be displayed for each track. Accordingly, a plurality of editing window WE can be displayed on the music editing screen WS. The editing window WE displays a sound-related image GV (first image) and a setting window image GS (second image). The setting window image GS is displayed such that a smaller window is further opened inside the editing window WE.

The sound-related image GV is an image corresponding to sound signals, and includes an image GRs corresponding to the image GR in the music editing screen WS and an image GF indicating the pitch of a waveform. While omitted in FIG. 9, the sound-related image GV can be displayed by an image imitating a waveform itself centered on the image GF. In this example, an image GTs indicating the playback position is further displayed in the editing window WE. The position of the image GTs in the editing window WE is fixed. Accordingly, as the playback position advances, the sound-related image GV flows relatively in the left direction AR. Therefore, the sound-related image GV is displayed extending in the horizontal direction (left-right direction) in the editing window WE.

In this example, the setting window image GS includes operation images GC4, GC5, GC6. The operation image GC4 is an image imitating a button for transposing the key. The operation image GC5 is an image imitating a slider for changing various setting values from the reference values. The operation image GC6 is an image imitating a slider for finely adjusting the sound generating timing. In this example, the setting window image GS further includes a setting image 800. The setting image 800 includes an image relating to the second parameter P2.

FIG. 10 is an example of a setting image according to the one embodiment. The setting image 800 includes an arc area 810 (first image area) for indicating an instruction value, and an arc area 820 (second image area) for indicating a control value. The arc areas 810, 820 are arranged adjacent to each other, and the arc area 810 is located outside of the arc area 820. In this example, both areas are defined as areas along a concentric arc. The starting points SP of the arc areas 810, 820 are positions indicating the minimum values, and are adjacent to each other. The ending points EP of the arc areas 810, 820 are positions indicating the maximum values, and are adjacent to each other.

An image CA indicating the instruction value is displayed in the arc area 810 extending from the starting point SP. The image CA is displayed in the arc area 810 within a range corresponding to the ratio of the instruction value relative to the maximum possible value of the instruction value. If the ratio of the instruction value is 100%, the image CA extends from the starting point SP to the ending point EP. The instruction value is indicated by the position of the end portion of the image CA, but can be indicated by another form of display as long as the instruction value is indicated by a position in the arc area 810.

An image LA indicating the control value is displayed in the arc area 820 extending from the starting point SP. The image LA is displayed in the arc area 820 within a range corresponding to the ratio of the control value relative to the maximum possible value of the control value. If the ratio of the control value is 100%, the image LA extends from the starting point SP to the ending point EP. The control value is indicated by the position of the end portion of the image LA, but can be indicated by another form of display as long as the instruction value is indicated by a position in the arc area 820.

As described above, the instruction value corresponds to the instruction value of an operator. The control value corresponds to a value that is actually reflected on the generation of the sound signal Wa, such as a value obtained by correcting the setting value of the second parameter P2 using the instruction value. That is, if a track uses the sound generation unit 100a, the control value corresponds to the value of the second parameter P2 provided to the second trained model 130. If a track uses the sound generation unit 100b, the control value can be the value of the third parameter P3.

In this example, the setting image 800 includes a type image PA and an instruction value image NA that are positioned so as to be surrounded by the arc areas 810, 820. The instruction value image NA is an image indicating the ratio of the instruction value described above. The type image PA is an image indicating the type of information selected from the second parameters P2. Here, the type image PA indicates that power information has been selected from the second parameters P2. The instruction value image NA indicates that the ratio of the instruction value is 74%. Accordingly, when 100% is from the starting point SP to the ending point EP, the image CA is displayed so as to show a range of 74% from the starting point SP.

A display control method when displaying the setting image 800 will now be described. The display control method described here is executed by the editing window WE being displayed.

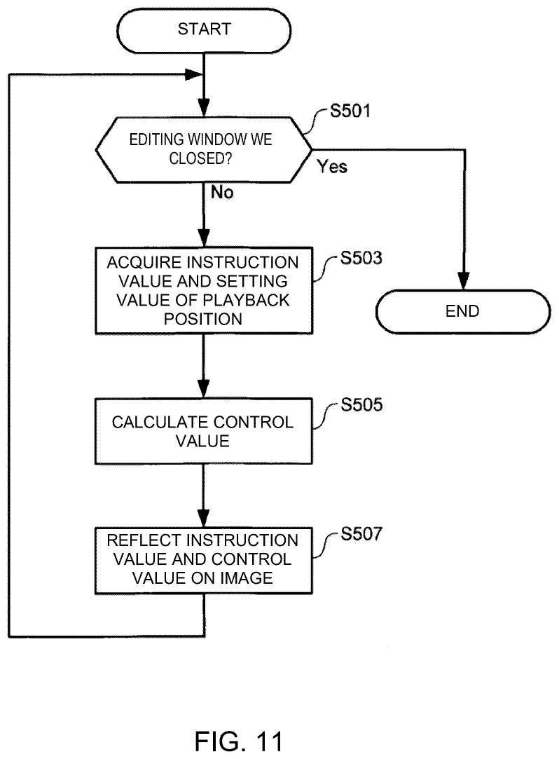

FIG. 11 is a flowchart showing the display control method according to the one embodiment. If an instruction to close the editing window WE has not been received (step S501; No), the control unit 11 acquires the setting value corresponding to the current playback position and the current instruction value (step S503). The control unit 11 calculates the control value in accordance with the acquired setting value and instruction value (step S505). The formula for calculating the control value is set in advance with at least the setting value and the instruction value serving as variables. The formula can differ depending on the type of the second parameter P2. The control unit 11 reflects the instruction value on the image CA, reflects the calculated control value on the image LA (step S507), and returns to the process of step S501. When an instruction to close the editing window WE is received (step S501; Yes), the control unit 11 ends the process.

In this manner, in the setting image 800, the image CA corresponding to the instruction value and the image LA corresponding to the control value are arranged in proximity to each other. Accordingly, the user can easily confirm the instruction value when being operated by the operator, and the control value that is actually reflected on the generated sound. Accordingly, it is possible to improve the music production efficiency in a software environment in which sound is generated in accordance with the playback position.

The control unit 11 changes the position of the setting window image GS in the editing window WE in accordance with user instructions. At this time, when the setting window image GS moves to a position overlapping the sound-related image GV, the setting window image GS is an image on a newly-opened window in the editing window WE, and thus obscures the sound-related image GV. In this example, the control unit 11 moves the position of the sound-related image GV in the editing window WE so as to avoid the setting window image GS, so that the sound-related image GV would not be obscured.

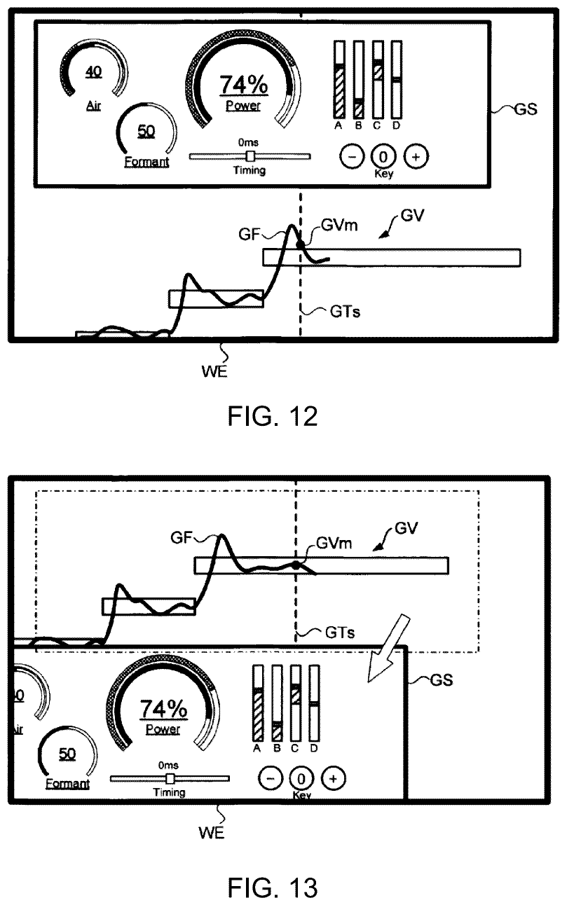

FIGS. 12 and 13 show an example of the editing window according to the one embodiment. In the editing window WE shown in FIG. 12, when the setting window image GS moves to a position shown in FIG. 13 in accordance with a user's instruction, the position of the sound-related image GV moves from the position shown in FIG. 12 to the position shown in FIG. 13. As shown in FIGS. 12 and 13, when the setting window image GS is moved, the sound-related image GV moves to an area in the editing window WE that is largely empty with respect to the setting window image GS. Here, the intersection between the sound-related image GV (the image GF in this example) and the image GTs is referred to as reference point GVm. The reference point GVm can be at a different position so long as the position is linked to the sound-related image GV.

Next, a display control method when moving the setting window image GS will be described. The display control method described here is executed by the editing window WE containing the sound-related image GV and the setting window image GS being displayed.

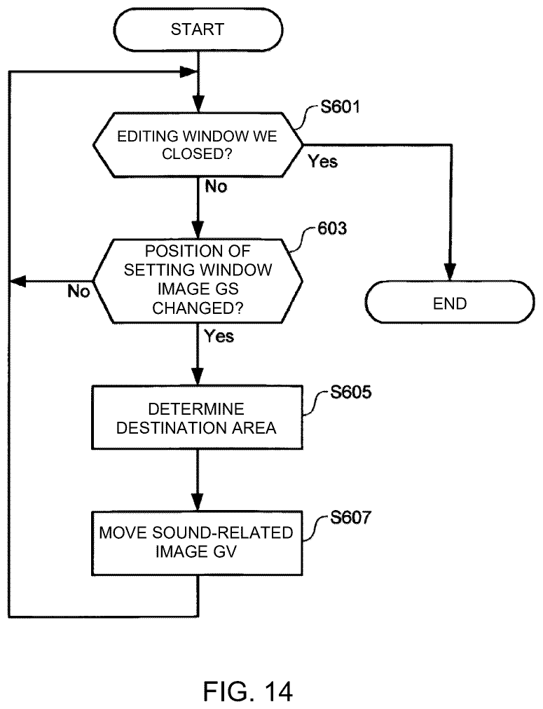

FIG. 14 is a flowchart showing a display control method according to the one embodiment. The control unit 11 waits for an instruction to close the editing window WE or an instruction to change the position of the setting window image GS (step S601; No, step S603; No). When an instruction to change the position of the setting window image GS is received (step S603; Yes), the control unit 11 determines a destination area within the display area of the editing window WE that satisfies a prescribed condition (step S605). The control unit 11 moves the sound-related image GV to the destination area (step S607) and returns to the process of step S601. When an instruction to close the editing window WE is received (step S601; Yes), the control unit 11 ends the process.

A method for determining the destination area in step S605 will now be described.

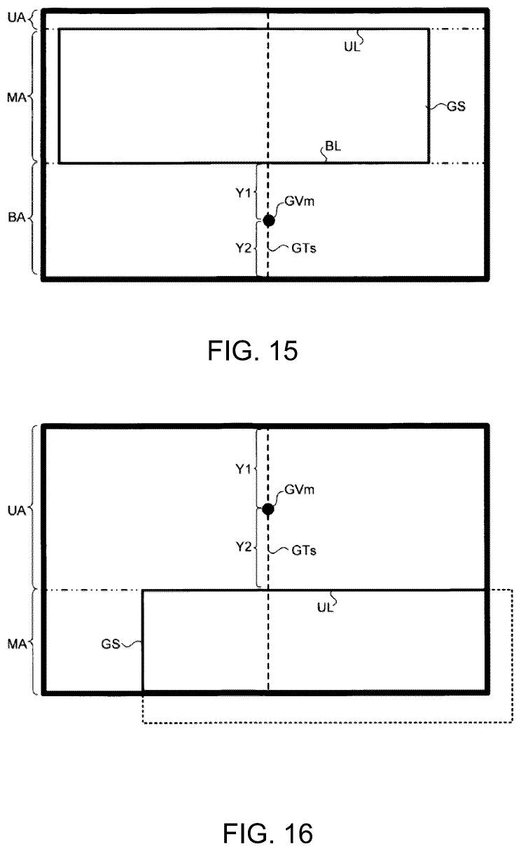

FIGS. 15 and 16 are diagrams describing the positional relationship between the sound-related image and the setting window image according to the one embodiment. FIGS. 15 and 16 show a simplified configuration of the editing window WE. As shown in FIG. 15, the display area of the editing window WE is divided into a plurality of areas with the setting window image GS as a reference. In this example, the plurality of areas are three areas UA, MA, BA obtained by dividing the editing window to be aligned in the vertical direction (up and down) The area UA is an area above the upper end UL of the setting window image GS. The area BA is an area below the lower end BL of the setting window image GS. The area MA is the area sandwiched between the upper end UL and the lower end BL of the setting window image GS. Depending on the position of the setting window image GS, there are cases in which the area UA or the area BA does not exist. For example, in the example shown in FIG. 16, the area BA does not exist.

The control unit 11 compares the area UA and the area BA and determines the larger area as the destination area. In this example, the larger area is the area with the greater vertical length. A larger area can be an area with a larger area. In the example shown in FIG. 15, the destination area is the area BA. In the example shown in FIG. 16, the destination area is the area UA. The control unit 11 displays the sound-related image GV such that the reference point GVm is positioned on the image GTs at the center of the destination area in the vertical direction. Accordingly, as shown in FIGS. 15 and 16, the length Y1 from the reference point GVm to the upper end of the destination area becomes the same as the length Y2 from the reference point GVm to the lower end of the destination area. The lengths Y1 and Y2 can be different. The relative relationship between the lengths Y1 and Y2 can be different depending on whether the destination area is the area UA or the area BA. For example, if the destination area is the area UA, the length Y2 can be greater than the length Y1, and if the destination area is the area BA, the length Y1 can be greater than the length Y2. In this manner, the sound-related image GV approaches the outer periphery of the editing window WE, slightly away from the setting window image GS.

When the setting window image GS moves from the position shown in FIG. 15 in the lower right direction and reaches the position shown in FIG. 16, the reference point GVm of the sound-related image GV moves from the position shown in FIG. 15 to the position shown in FIG. 16. The movement of the reference point GVm can be executed after the movement of the setting window image GS stops. The movement of the reference point GVm can be sequentially carried out during the movement of the setting window image GS. In the latter case, first, the reference point GVm gradually moves downward in the process of the setting window image GS moving from the position shown in FIG. 15 to the position shown in FIG. 16. Then, at the timing at which the vertical length of the area UA becomes greater than that of the area BA, the reference point GVm moves significantly from the area BA to the area UA.

In this manner, when the setting window image GS is moved in the editing window WE, the sound-related image GV moves to a larger area, making it possible to maintain a state in which the sound-related image GV can be easily seen. Accordingly, it is possible to improve the music production efficiency in a software environment in which sound is generated in accordance with the playback position.

### Modified Examples

The present disclosure is not limited to the embodiment described above, and encompasses various other modified examples. For example, the embodiment described above has been described in detail in order to clearly explain the present disclosure, but is not necessarily limited to an embodiment provided with all of the configurations that have been described. In addition, another configuration can be added to the configuration of the one embodiment, or some of the configurations can be deleted or replaced with another configuration. Some modified examples will be described below.

(1) A process executed by the above-mentioned program 13a is not limited to being executed entirely in the data processing device 1. For example, some processes can be executed in an external device connected via a network. For example, processes that do not require strict real-time performance, such as the process of acquiring the intermediate feature data MV by using the first trained model to, can be executed by an external device.

(2) The information displayed in the setting image 800 is not limited to information relating to the second parameter P2 of the sound control data CDa. For example, information relating to the third parameter P3 of the sound control data CDb can be displayed in the setting image 800.

(3) The areas in which the images LA and CA are arranged in the setting image 800 are not limited to the arc shapes shown in the arc areas 810, 820. For example, this area can have be linear, curved, or have a combination of linear and curved shapes. Regardless of the shape, it is preferable for the starting points SP of the two areas to be adjacent to each other and the ending points EP of the two areas to be adjacent to each other.

(4) When dividing the display area in the editing window WE into a plurality of areas to determine the destination area for the sound-related image GV, the division can be carried out by another method. For example, instead of being divided so as to be arranged vertically, the plurality of areas can be divided so as to be arranged horizontally, or divided so as to be arranged horizontally and vertically. In any case, it suffices if an area of the editing window WE in which the setting window image GS does not exist is divided into plurality of areas. It suffices if, of the plurality of areas, a larger area is determined as the destination area satisfying a prescribed condition. If the editing window WE is divided into three or more areas, the destination area does not need to be the largest area, and can be, for example, the second largest area.

(5) It suffices if the intermediate feature data MV are updated between when the first parameter P1 is changed and when playback is started in accordance with a start playback instruction. That is, the timing for updating the intermediate feature data MV can be immediately after the first parameter P1 is changed, or after a prescribed time has elapsed since the change. The timing for updating the intermediate feature data MV can be unrelated to when the first parameter P1 is changed, as exemplified below.

First example: the control unit 11 temporarily saves the first parameter P1 at predetermined time intervals. When saving, the control unit 11 compares previously saved information and information that is to be saved. When at least one piece of information from among the temporarily saved first parameters P1 has been changed, the control unit 11 updates the intermediate feature data MV.

Second example: when a start playback instruction is received, the control unit 11 determines whether at least one piece of information from among the first parameters P1 has been changed after the reception of the previous start playback instruction, and if there has been a change, updates the intermediate feature data MV. If a start playback instruction has never been received after execution of the program (after the software was started), the control unit 11 can determine whether at least one piece of information from among the first parameters P1 has been changed when the software was started or after the music data 13b were read thereafter.

### Effects of This Disclosure

According to this disclosure, it is possible to improve music production efficiency in a software environment for generating sounds corresponding to the playback position.

What is claimed is:

1. A signal generation method comprising:
acquiring intermediate feature data corresponding to a prescribed time step by providing, to a first trained model, from among sound control data including a first parameter and a second parameter for controlling generated sounds at a plurality of time steps corresponding to a passage of time, the first parameter in a prescribed time range that includes before and after the prescribed time step;
updating the intermediate feature data in response to a value of the first parameter being changed; and
generating a sound signal in accordance with data obtained by providing the second parameter and the intermediate feature data that has been updated to a second trained model, in response to receiving a start playback instruction.

2. The signal generation method according to claim 1, wherein
the second parameter includes instruction information corresponding to an instruction value of an operator.

3. The signal generation method according to claim 2, wherein the first parameter includes phoneme information or pitch information.

4. The signal generation method according to claim 3, further comprising
displaying a sound control image corresponding to the value of the first parameter based on the sound control data, and
changing the value of the first parameter in response to receiving a change operation on the sound control image.

5. The signal generation method according to claim 1, wherein
the second trained model generates sound feature data corresponding to each time step for generating the sound signal, and
as the sound feature data corresponding to a prescribed time step are generated, the sound feature data corresponding to a time step before the prescribed time step are further provided to the second trained model.

6. The signal generation method according to claim 1, further comprising
determining a control value for controlling the generated sounds corresponding to the passage of time based on an instruction value from an operator and a setting value determined in advance in a time series, and
displaying a setting image including a first image area for indicating the instruction value and a second image area adjacent to the first image area for indicating the control value, wherein
the second parameter includes the control value.

7. The signal generation method according to claim 1, further comprising
displaying, in a prescribed display area, a first image corresponding to the sound signal and a second image including an image related to the second parameter;
changing a position of the second image in the prescribed display area in accordance with an input instruction; and
moving the first image to an area that satisfies a predetermined condition from among a plurality of areas obtained by dividing the prescribed display area with the second image as reference, in response to changing the position of the second image.

8. A signal generation method comprising:
displaying
a first area including a first image corresponding to a first parameter for controlling a generated sound of a first track, the first parameter including phoneme information or pitch information,
a second area including a second image corresponding to a second parameter for controlling the generated sound of the first track, and
a third area including a third image corresponding to a third parameter for controlling a generated sound of a second track;
displaying the first image and the third image that correspond to a current playback position in the first area and the third area in response to receiving a start playback instruction;
generating a first sound signal of the first track and a second sound signal of the second track, the first sound signal and the second signal corresponding to the playback position;
outputting a mixed sound of the first sound signal and the second sound signal; and
in response to receiving an instruction to change the second parameter after the start playback instruction, reflecting the second parameter that has been changed on the first sound signal at the playback position.

9. The signal generation method according to claim 8, wherein
the first parameter includes the phoneme information.

10. The signal generation method according to claim 8, wherein
the second sound signal at the playback position is generated from information of the third parameter at the playback position or before the playback position.

11. The signal generation method according to claim 8, wherein
in response to receiving an instruction to change the third parameter after the start playback instruction, the third parameter that has been changed is reflected on the second sound signal at the playback position.

12. The signal generation method according to claim 8, wherein
the first sound signal at the playback position includes information of the first parameter after the playback position.

13. The signal generation method according to claim 8, wherein
the instruction to change the second parameter is input by an operation on an image displayed in the second area.

14. A non-transitory computer-readable medium storing a program for causing a computer to execute the signal generation method according to claim 1.

15. A display control method comprising:
determining a control value for controlling generated sounds in accordance with a passage of time based on an instruction value from an operator and a setting value determined in advance in a time series;
generating a sound signal based on the control value and sound control data for generating the generated sounds corresponding to the passage of time; and
displaying a setting image including a first image area for indicating the instruction value and a second image area adjacent to the first image area for indicating the control value.

16. The display control method according to claim 15, wherein
the instruction value is indicated by a position in the first image area,
the control value is indicated by a position in the second image area,
a position indicating a minimum value in the first image area is adjacent to a position indicating a minimum value in the second image area, and
a position indicating a maximum value in the first image area is adjacent to a position indicating a maximum value in the second image area.

17. A display control method comprising:
displaying, in a prescribed display area,
a first image corresponding to a sound signal generated based on sound control data for controlling generated sounds corresponding to a passage of time, the sound control data including a first parameter and a second parameter, and
a second image including an image related to the second parameter;
changing a position of the second image in the prescribed display area in accordance with an input instruction; and
moving the first image to an area that satisfies a predetermined condition from among a plurality of areas obtained by dividing the prescribed display area with the second image as reference, in response to changing the position of the second image.

18. The display control method according to claim 17, wherein
the first image is displayed extending left and right in the display area,
the plurality of areas include at least two areas divided so as to be aligned vertically with the second image as reference, and
the area that satisfies the predetermined condition is a larger area of the at least two areas.

19. A non-transitory computer-readable medium storing a program for causing a computer to execute the display control method according to claim 15.
